(19) United States
(12) Patent Application Publication
(10) Pub. No.: US 2026/0329607 A1
(43) Pub. Date: Oct. 22, 2026

(54) METHOD FOR AUTOMATICALLY GENERATING UI GUIDED WALKTHROUGH

(71) Applicant: HEWLETT PACKARD ENTERPRISE DEVELOPMENT LP, Spring, TX (US)

(72) Inventors: JONATHAN TARAGIN, Netanya Industrial Park (IL); Idan AHARONI, Netanya Industrial Park (IL); Shay TURJEMAN, Netanya Industrial Park (IL)

(21) Appl. No.: 19/182,307

(22) Filed: Apr. 17, 2025

(51) Int. Cl. G06F 9/451; G06F 16/334

(52) U.S. Cl. CPC G06F 9/453; G06F 16/3347

(57) ABSTRACT

Systems and methods are provided for automated user interface (UI) walkthrough generation. Examples include receiving, at an answer generator component, a user query and generating an answer to the user query. The answer can be input into a UI flow generator component, which translates the answer into an ordered set of UI pages and UI components making up a UI flow and builds a data object containing information representative of the UI flow. The UI flow can be presented at a UI with which a user can effectuate the answer to the user query.

### BACKGROUND

Artificial intelligence (AI) technologies, such as large language models (LLMs), Retrieval-Augmented Generation (RAG), and so on have/continue to be leveraged to improve the operation of various systems and mechanisms. For example, LLMs and RAG systems can be used to generate responses to user queries in a chatbot context.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 depicts a schematic block diagram of an example system for creating and providing an interactive user interface walkthrough, in accordance with examples disclosed herein.

FIG. 2 is a block diagram of an example user interface walkthrough generation system, in accordance with implementations of the present disclosure.

FIG. 3 depicts an example process pipeline flow of the user interface walkthrough generation system of FIG. 2, in accordance with examples disclosed herein.

FIGS. 4 and 5 depict example sub-processes that can be executed during the process pipeline flow of FIG. 3.

FIG. 6 depicts an example user interface that may be utilized for generating interactive UI walkthroughs, in accordance with an example of the present disclosure.

FIG. 7 depicts an example user interface mapping, in accordance with an example of the present disclosure.

FIG. 8 illustrates an example page of a user interface that can be generated by the examples disclosed herein.

FIGS. 9A and 9B depict examples steps of an interactive user interface walkthrough, according to an example implementation of the present disclosure.

FIG. 10 is an example computing component that may be used to implement various features of dynamic UI walkthrough generation in accordance with the implementations disclosed herein.

FIG. 11 is a computing component that may be used to implement examples of the disclosed technology.

The figures are not exhaustive and do not limit the present disclosure to the precise form disclosed.

### DETAILED DESCRIPTION

Product or service documentation is often provided to a user so that the user can understand or learn how to use that product or service. However, it can be difficult for a user to make his/her way through conventional, e.g., textual, documentation. As can be readily appreciated, some products come with pamphlets of varying size or length, in multiple languages, that describe the features of a product, how to access and use those features, how to troubleshoot problems that arise during use of the product, etc. In some cases, documentation can reproduce images of a user interface (UI) that a user may interact with in order to direct or control the product or service. For example, a document creator may assume a user will want to change a setting, and conventional documentation will provide images reproducing the change-setting user UI, and, e.g., highlight buttons the user will have to press to change the setting.

However, these are “static” representations based on a document creator's assumption of the needs of a user. Conventional documentation may not necessarily capture all the conceivable ways in which a user may interact with a product/service and its corresponding UI. Moreover, depending on the product/service, the flow of button presses/operations that a user may take to reach some feature or setting can differ. Unless the document creator contemplates each/every possible interaction and manner of reaching that interaction, users may be left with scenarios without corresponding UI instructions. Moreover, and even if all scenarios may be contemplated and presented in conventional documentation, users may still encounter difficulties operating or using a product or service. For example, instructions presented in conventional documentation may be difficult to comprehend and can be lengthy, which can make it difficult for a user to locate relevant answers to specific questions they may have.

Accordingly, examples of the disclosed technology provide a system that can be integrated into a product or service offering (referred to herein as an offering or offerings) that a user may interact with (e.g., input questions or inquiries) to obtain answer(s). In examples, the user questions can be submitted to a generative AI model, such as an LLM, that can generate answers that are probabilistically relevant to the users'questions about a task. The examples disclosed herein may take the answer(s) and generate a UI walkthrough that guides the user to accomplish the task asked about while the user is interacts with the UI in real-time. In examples, the answer(s) can be supplied to the generative AI model, which translates the answer(s) into an ordered set of steps of a UI flow and builds a data object containing the ordered steps. The data object can be provided to the UI to present the answer(s) and guide the user through the UI flow as a guided walkthrough that directs the user through the order steps, while the user interacts with the UI to effectuate the answer to the question.

The examples disclosed herein may leverage a pipelined flow, wherein a first “answer generator” leverages stored documentation relevant to an offering to provide the answer(s) to a question(s) of the offering submitted by a user via an end-user device. The generated answer(s) can be sent to a UI and presented to the user on the end-user device. The generated answer(s) can be input into a UI flow generator. The UI flow generator can access UI mapping documents that represent a structural layout of the UI as a set of UI pages and UI components by mapping the UI components to each UI page. Aspects of the UI divided across the set of UI pages can be tagged, e.g., names can be assigned to each component (e.g., button, control, setting, and so on). A UI mapping document can be created that describes each UI component and the UI component's purpose mapped to each UI page. The generative AI model can be leveraged to translate the answer(s) into an ordered set of UI pages and UI components that make up a flow that is representative of the interactions needed to accomplish or effectuate the answer. The examples herein can build a data object, such as a JavaScript Object Notation (JSON) object, that contains the generated flow information, which can be returned to the end-user device and presented as an interactive walkthrough of the answer(s).

As used herein, the term “real-time” may refer to a level of responsiveness that a user or system executes as sufficiently immediate for a particular process or determination to be made, or that enables the processor to keep up with some subsequent process.

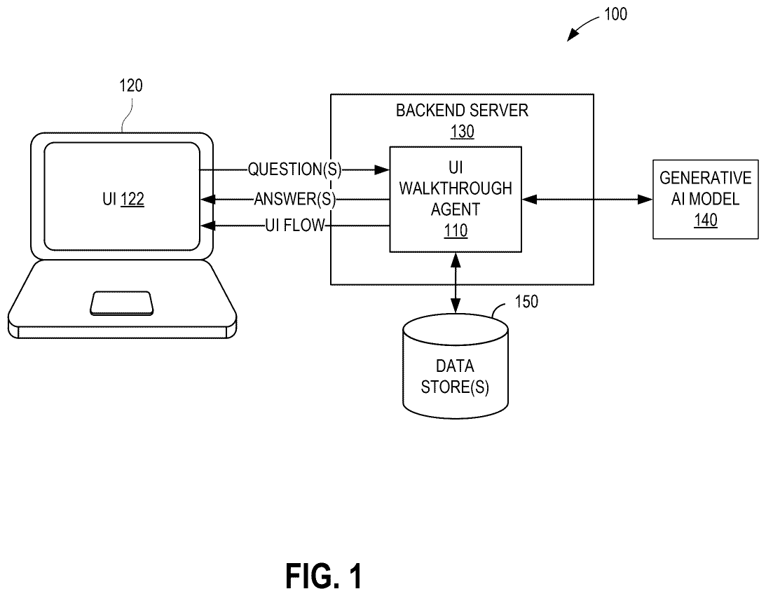

FIG. 1 depicts a schematic block diagram of an example system 100 for creating and providing a UI, in accordance with examples disclosed herein. The system 100 includes a backend server 130 communicably coupled (e.g., via wired or wireless communication connection) to a frontend system 120. The backend server 130 may be configured to create one or more UIs 122 for one or more product or service offerings, such as web-based or script-based UIs. In examples, the backend server 130 may generate UIs on a per-offering basis (e.g., one UI for a given product or service offering). The backend server 130 may forward or transmit data to the frontend system 120 via an application programming interface (API), which can ingest the data and present the UI 122 to a user as a graphical user interface (GUI). In examples, the backend server 130 may comprise one or more dedicated servers and/or may one or more comprise cloud-based servers capable of generating the UIs. Backend server 130 may comprise web servers hosting one or more websites, web services, and/or web-based portals, which may comprise the one or more UIs.

The one or more UIs 122 may comprise a combination pages displaying content and components, which can be rendered on a display screen as a GUI. For example, a UI 122 may comprise a plurality of pages containing content and components corresponding to actions that can be executed on the plurality of pages. Each page of the UI 122 may comprises a set of components corresponding to actions that can be executed from a respective page. Components may include, but are not limited to, text, images, videos, animations, references (e.g., hyperlinks), frames, inputs (e.g., textboxes, text areas, checkboxes, chatboxes, drop-down menus, interactive icons, buttons etc.), scripts (e.g., JavaScript), and the like. In examples, one or more pages may be linked in an order manner according to executing one or more components. For example, executing one or more components (e.g., buttons, references, etc.) on one page may generate another page, which can replace the one page or be superimposed (e.g., overlaid) on the one page.

In examples, backend server 130 may transmit or generate the pages of the UI in response to requests from the frontend system 120. For example, the frontend system 120 may interact with a server (for example through an application executing on the frontend system 120) by requesting one or more pages of the UI based on user interactions with a UI 122 at the frontend system 120. In examples, the frontend system 120 may receive inputs from a user as interaction(s) with components of a page of the UI 122 (e.g., keystrokes, screen touches, gestures, voice input, etc.). The frontend system 120 may send the interactions to the backend server 130 as a request for content (e.g., a page of the UI or other content offered by the service/product offering related to the UI 122), which can be processed by the backend server 130. The backend server 130 may respond with actions corresponding to the component executed by the user interaction. For example, a next page of the UI can be generated and provided to frontend system 120 for display to the user. As another example, functionality of the server/product offering corresponding to the UI can be executed according to the component executed. In examples, the frontend system 120 may comprise an end-user device. Example end-user devices include, but are not limited to, desktop computers, laptop computers, tablet computers, smart phones or other mobile phones, wearable mobile devices, servers, electronic kiosks, and any type of computing device capable of wired and/or wireless communication.

In the example of FIG. 1, the backend server 130 comprises an UI walkthrough agent 110 that is configured to generate and provide automated dynamic on-demand walkthroughs that provide step by step interactive instructions for using the UI 122, while the user interacts with the UI 122 in real-time. For example, the UI walkthrough agent 110 may be integrated into the backend server 130 (e.g., installed therein), such that a dynamic interactive walkthrough can be generated according to specific questions related to the UI 122 submitted by the user at the frontend system 120. For example, the user may input one or more questions into the UI 122 at the frontend system 120, which can be provided to the UI walkthrough agent 110. The question(s) can be related to functionality offered by the UI 122, for example, related to completing one or more tasks at the backend server 130 through the UI 122. The UI walkthrough agent 110 takes the questions and generates an interactive walkthrough that is specific to the context of the question(s) to accomplish the functionality prompted. The interactive walkthrough can be provided to the frontend system 120 and executed thereat to provide step by step instructions to the user, which can be rendered and overlaid on the UI 122 in real-time as the user interacts with the UI 122 to accomplish the prompted tasks.

In examples, the UI walkthrough agent 110 may leverage a generative AI model 140 to dynamically generate interactive UI walkthroughs that are targeted to user a submitted question(s). For example, the UI walkthrough agent 110 may provide the question(s) from the frontend system 120 to the generative AI model 140 as an input query and the generative AI model 130 can generate one or more answers that are probabilistically relevant to the input query. In examples, the generative AI model 140 may be a LLM or similar generative model. The UI walkthrough agent 110 may forward the answer(s) to frontend system 120, which can present the answer to the user within the UI 122, for example, overlaid/superimposed on or as page of the UI. In some examples, the UI 122 may comprise a chatbox, which can be overlaid on a page of the UI or as a separate page of the UI, into which the question(s) can be submitted and the answer(s) can be presented to the user.

In examples, the UI walkthrough agent 110 may be configured to leverage RAG techniques to augment the input query prior to submitting to the generative AI model 140. For example, UI walkthrough agent 110 may be configured to retrieve resources that are probabilistically relevant to the question(s). These resources may be used to define a context of the question. The resources may be stored to a knowledge base within one or more data store(s) 150. The knowledge base may comprise documents or other data (e.g., images, videos, audio, etc.) related to functionality, operations, and general use of the UI 122. The UI walkthrough agent 110 can augment the input query by adding the retrieved resources to the input query and submitting the augmented input query to the generative AI model 140. The generative AI model 140 can generate an answer that is responsive to the question by applying its learned knowledge to the augmented input query according to the context defined by the retrieved resources. In examples, the resources added to the input query may be resources that differ from those used to train the generative AI model 140. The added resources may be analyzed and processed by the trained generative AI model 140 to output a response that is relevant to the context of the question(s).

To generate the interactive UI walkthrough, the UI walkthrough agent 110 may submit the generated answer(s) to the generative AI model 140 as an answer query. For example, the UI walkthrough agent 110 may provide the answer(s) from the generative AI model 140 back into the generative AI model 140 as the answer query and the generative AI model 130 can generate a UI walkthrough that is probabilistically relevant to executing the answer(s) on the UI 122. The UI walkthrough agent 110 may forward the UI walkthrough to frontend system 120, which can present the UI walkthrough to the user within the UI 122, for example, overlaid/superimposed on pages of the UI 122. In examples, the generative AI model can translate the answer query into an ordered set of steps of a UI flow that can be executed on the UI 122 to accomplish the prompted tasks. In examples, the UI walkthrough agent 110 may be configured to build the UI walkthrough as a data object containing the ordered steps generated by the generative AI model. The UI walkthrough agent 110 can provide the data object to the frontend system 120, which executes the data object to guide the user through the UI flow as an interactive walkthrough that directs the user through the order steps, while the user interacts with the UI 122 to complete the steps in real-time. For example, the user may interact with the UI 122 at certain steps to effectuate the steps and transition the UI walkthrough to a next step of the UI flow, thereby providing the interactive UI walkthrough that accomplishes the prompted tasks.

In examples, the RAG techniques, described above, can be utilized by the UI walkthrough agent 110 to augment the answer query for submission to the generative AI model 140. For example, UI walkthrough agent 110 may retrieve a UI mapping document stored to the data store(s) 150. The UI mapping document may represent a structural layout of the UI 122 as a set of pages and components by mapping the components to each page. Aspects of the UI 122 divided across the set of pages can be tagged, e.g., names can be assigned to each component (e.g., button, control, setting, and so on). The UI mapping document can be created that describes each component and the component's purpose mapped to each page. In examples, the data store(s) 150 may store a number of UI mapping documents, for example, on a per-UI basis (e.g., one document for each UI). In some examples, a UI mapping may be provided as a set of documents, each of which represent one or more pages of a UI. The answer query can be augmented by adding the UI mapping document to the answer query. The generative AI model 140 can then output the order set of steps by applying its learned knowledge to the augmented answer query.

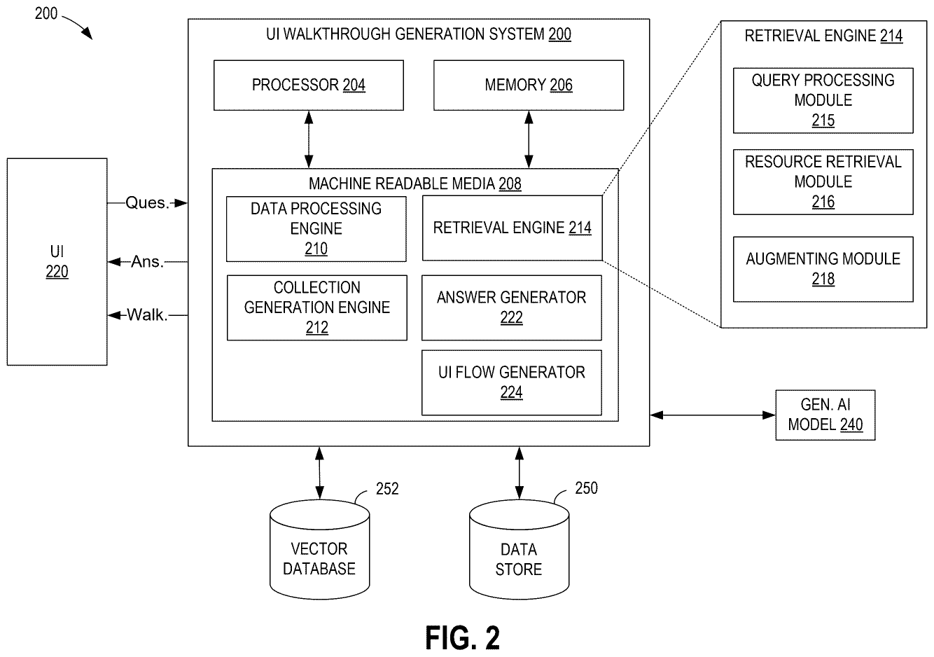

FIG. 2 is a block diagram of an example UI walkthrough generation system 200, in accordance with implementations of the present disclosure. In the example of FIG. 2, system 200 is communicable coupled (e.g., via wired or wireless communication connection) to a UI 220, a generative AI model 240, and a plurality of data stores 252-250. System 102 may be a server computer that communicates via network communications to other devices accessible on the network, including computing devices running UI 220, generative AI model 240, and data stores 250-252. In some examples, the data stores 250-254 may be cloud-based databases, included as part of system 200, or combinations thereof.

In an example, system 200 may be implemented as UI walkthrough agent 110 of FIG. 1. In this case, the generative AI model 240 may be an example implementation of generative AI model 140 and UI 220 may be an example of UI 122 of FIG. 1. In examples, the data stores 250-252 may be examples of data store(s) 150. For example, data store 250 may store various documents related to the UI 220, for example, documents describing functionality, operations, and general use of UI 220. Additionally, data store 250 may store one or more UI mapping documents that maps components of UI 220 to pages of UI 220.

Generative AI model 240 may be hosted by a third party system. In examples, generative AI model 240 may be trained on vast volumes of data from a general knowledge base and configured to generate outputs for queries, such as answering queries, translating languages, and completing sentences. In examples, the generative AI model 240 may be one or more LLM tools, such as but not limited to, the GPT series of models, Gemini, LLaMA models, and the like

The UI 220 may comprise a plurality of pages and components for interacting with the UI 220, which can be rendered on a display screen of an end-user device. As noted above, UI 220 may be an example of UI 122. A user may submit one or more question(s) into the system 200 with a goal being to obtain an output from the generative AI model 240 that is relevant to the questions. In examples, a user may input questions about UI 220, such as functionality, operations, and general use of UI 220, by interacting with UI 220. In some examples, the UI 220 may comprise a component (e.g., a textbox, chatbox, dropdown menu, etc.) that a user may interact with (e.g., via keystrokes, screen touches, gestures, voice input, and the like) to input one or more questions about the UI 220. The question(s) may be related to tasks (e.g., functions and operations) that can be accomplished through the UI 220.

The system 200 can be configured to generate and provide automated dynamic on-demand walkthroughs that provide step by step interactive instructions for using the UI 220 to accomplish the prompted tasks, while the user interacts with the UI 122 in real-time. That is, the system 200 may receive the question(s) from UI 220 and return an interactive walkthrough that is dynamically generated to contain step by step instructions for completing a task related to the question(s). The step by step instructions can be executed by a user via the UI 220 concurrently with each step being presented to the user via the UI 220.

In the example of FIG. 2, the system 200 comprises processor 204, memory 206, and machine readable media 208. Machine readable media 208 may comprise, for example, data processing engine 210, collection generation engine 212, retrieval engine 214, answer generator 222, and UI flow generator 224.

Processor 204 may comprise a general-purpose or special-purpose processing engine such as, for example, a microprocessor, controller, or other control logic. Processor 104 may be connected to a bus, although any communication medium can be used to facilitate interaction with other components of system 202 or to communicate externally.

Memory 206 may comprise random-access memory (RAM) or other dynamic memory for storing information and instructions to be executed by processor 204. Memory 206 might also be used for storing temporary variables or other intermediate information during execution of instructions to be executed by processor 204. Memory 206 may also comprise a read only memory (“ROM”) or other static storage device coupled to a bus for storing static information and instructions for processor 204.

Machine readable media 208 may comprise one or more interfaces, circuits, and modules for implementing the functionality discussed herein. Machine readable media 208 may carry one or more sequences of one or more instructions that can be executed by processor 204. Such instructions embodied on machine readable media 208 may enable system 200 to perform features or functions of the disclosed technology as discussed herein. For example, the interfaces, circuits, and modules of machine readable media 208 may comprise, for example, the data processing engine 210, the collection generation engine 212, the retrieval engine 214, the answer generator 222, and the UI flow generator 224.

Data processing engine 210 may be configured to process resources to extract keywords or phrases. In examples, the system 202 may access the documents stored in data store 250. The documents may correspond to a knowledge base on the functionality, operations, and general use of the UI 220. For example, the resources may contain information describing the UI 220 in textual documents (e.g. PDFs, documents generated by word processor programs, etc.), webpages, charts, graphs, images, videos, audio, multimedia content and the like. In any event, data processing engine 210 may function to access each external resource and process the external resource to obtain keywords and/or phrases. In the case of textual documents, webpages, and the like, the data processing engine 210 may execute natural language processing (NLP) to extract key features, such as keywords and/or key phrases. In the case of videos, images, multimedia content, and the like, the data processing engine 210 may execute computer vision algorithms (e.g., CNN-based feature extract techniques and the like, as known in the art) to identify features, which can then be processed to obtain key features.

The collection generation engine 212 may be configured to collect the resources into a single logical grouping. These logical groupings can be referred to as a collection in certain vector databases, libraries in others (such as LangChain and the like), indexes (such as in the case of Pinecone and FAISS), tables of vectors (e.g., such as in PostgreSQL). For example, the collection generation engine 212 can be configured to generate one or more numerical representations for each resource of the data store 250. In an illustrative example, the collection generation engine 212 can convert the key phrases of each resource into one or more numerical representations, such as vectorized embeddings, which can be stored to the vector database 252. The vector database may be implemented according to any desired protocol, such as but not limited to LangChain, Pinecone, FAISS, PostgreSQL, or the like. In an example, the collection generation engine 212 can be configured to convert a given resource into a number of chunk numerical representations, such as chunk vectorized embeddings, for storage in vector database 252. Thus, in examples, a single resource can be stored as a number of chunk embeddings. In examples, resources can be indexed and stored in the vector database 252 as a plurality of resource numerical representations.

The retrieval engine 214 may be configured to execute a retrieval and augmentation process. For example, upon receiving an input, the retrieval engine may access the vector database 252 may generate a query from the input and locate resources that are probabilistically relevant to the query. For example, the retrieval engine 214 may be configured to execute an information retrieval and augmentation algorithm (e.g., a RAG process) that searches the vector database 252 to locate and retrieve those resources that are probabilistically relevant to the input. As will be described below, the input may comprise the question(s) from the UI 220 or an answer to the question(s) generated by the generative AI model 240.

In the example of FIG. 2, the retrieval engine 214 may comprise a query processing module 215, a resource retrieval module 216, and an augmenting module 218.

In examples, the query processing module 215 may be configured to process the input to extract key features (e.g., key words and phrases in the case of a textual query), similar to the data processing engine 210. In some examples, the query processing module 215 may submit the input to the data processing engine 210 for processing and receive extracted key features from the data processing engine 210. In examples, the query processing module 215 may be configured to generate a query from the input, for example, by generating a numerical representation of the input. For example, the query processing module 215 can be configured to convert the key features of the input into a vectorized embedding. The vectorized embedding (e.g., input numerical representation) may be used as the query for searching the vector database 252.

The resource retrieval module 216 may be configured to access the collection in the vector database 252 and execute the information retrieval algorithm to retrieve resources relevant to the query. For example, resource retrieval module 216 may be configured to compare the query to the resources to locate those resources that probabilistically relevant (e.g., most similar) to the query. The most relevant resources can be retrieved. In examples, the relevancy of the documents may be determined by computing a similarity between the query and each resource in the collection, as a vectorized embedding. In one example, a k number of resources having the highest similarity based on maximal marginal relevant (MMR) analysis may be determined as the most relevant and retrieved, where the value of k may be set as desired for a given application. In another example, a threshold similarity may be set in advance and any reference having a similarity above the threshold may be retrieved.

In an example, resource retrieval module 216 may be configured to execute an information retrieval algorithm that searches the resources using numerical representations stored in the vector database 252. For example, resource retrieval module 216 may obtain the query as an input numerical representation (e.g., a vectorized embedding and search the vector database 252 to locate numerical representations that are probabilistically similar to the query. In examples, the numerical representations of resources that are the most similar to the query may be retrieved, for example, using a k-nearest neighbor search based on MMR, as described above. In another example, resource retrieval module 216 may execute cosine similarity to compute a similarity score between the query and numerical representations of the resources. In yet other examples, similarity may be computed using, such as, but not limited to, Euclidean distance, Manhattan distance, Jaccard similarity, dot product, soft cosine, angular distance, and the like. In an example, the numerical representations of the resources can be sorted according to similarity score (e.g., highest similarity to lowest) and the most similar may be identified as probabilistically relevant to the query.

The augmenting module 218 may be configured to generate an augmented query and submit the augmented query to the generative AI model 240. For example, the augmenting module 218 may be configured to add the resource retrieved by the resource retrieval module 216 to the query as a context, which collectively define the augmented query. In examples where the resource are retrieved as numerical representations, augmenting module 218 may convert the numerical representations back into the resources that can be processed by the generative AI model 240. The augmented query can be feed to the generative AI model 240 via prompt engineering. As explained above, the generative AI model 240 applies its learned knowledge to the augmented query and generates an output that is responsive to the query according to the context defined by resources retrieved for the query.

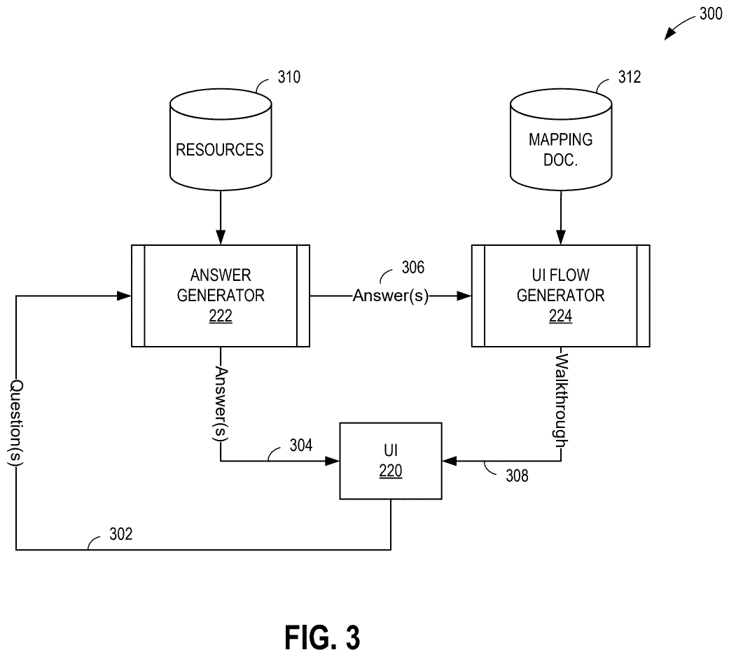

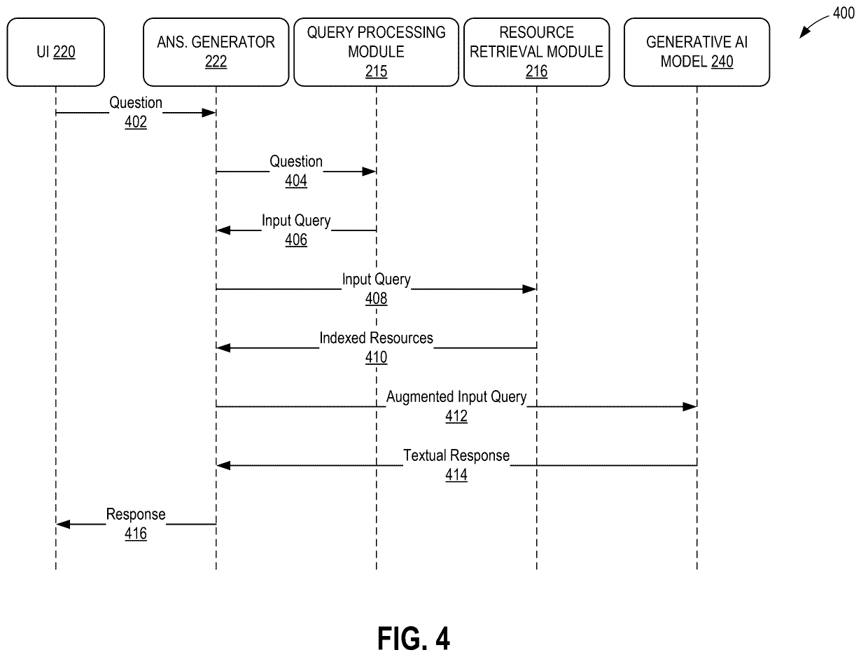

The answer generator 222 may be configured to obtain one or more answers to the question(s) received from the UI 220. In examples, answer generator 222 may utilize the retrieval engine 214 and generative AI model 240 to generate answer(s) that are probabilistically relevant to the question(s) according to context defined by resources stored in data store 250. Additional details on the functions of answer generator 222 are provided below in connection with FIGS. 3 and 4.

The UI flow generator 224 may be configured to obtain a UI flow using the answer(s) obtained by answer generator 222 to generate an interactive UI walkthrough that is specific to accomplishing tasks related to question(s) received from the UI 220. In examples, UI flow generator 224 may utilize the retrieval engine 214 and generative AI model 240 to generate a UI flow that is relevant to executing steps of the answer(s) within the UI 220 using a UI mapping stored in data store 250. Additional details on the functions of UI flow generator 224 are provided below in connection with FIGS. 3 and 4.

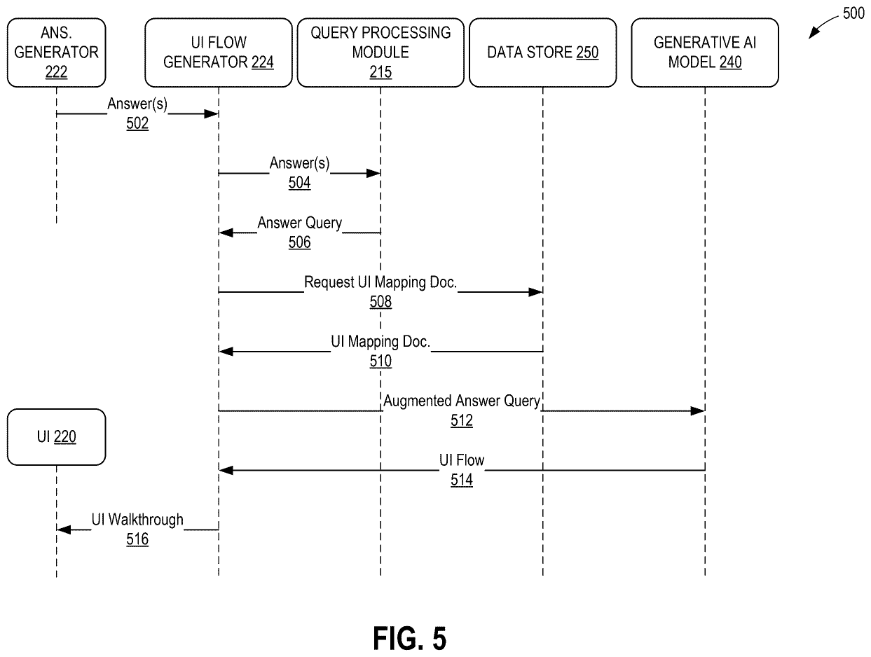

FIG. 3 depicts an example process pipeline flow 300 of the UI walkthrough generation system 200, in accordance with examples disclosed herein. The pipeline flow 300 may be executed using at least answer generator 222 and UI flow generator 224 to provide answer(s) and an interactive UI walkthrough relevant to question(s) received from UI 220. FIG. 3 will be described with reference to FIGS. 4 and 5. FIG. 4 depicts an example message flow 400 for generating answer(s) to question(s) and FIG. 5 depicts an example message flow 500 for generating a UI walkthrough from the answer(s) generated according to FIG. 4.

Pipeline flow 300 may be initiated when a user inputs one or more question(s) into a UI 220, for example, running on frontend system 120 of FIG. 1. The UI 220 may provide the question(s) 302 related to functionality offered by the UI 220 to the answer generator 222 as message 402 of FIG. 4. The question(s) 302 may prompt or otherwise be related to completing one or more tasks through the UI 220.

Referring to FIG. 4, the answer generator 222 can forward the question(s) 302 to the query processing module 215 as message 404. As described above, the query processing module 215 generates an input query as a numerical representation of the question(s) (e.g., vectorized embeddings of the questions(s)). The query processing module 215 returns the input query to the answer generator 222 as message 406.

The answer generator 222 can send message 408 containing the input query, to the resource retrieval module 216. As described above, resource retrieval module 216 searches the vector database 252 for resources that are most similar to the input query. The vector database 252 may store numerical representations of the resources as a collection that can be searched using the input query to locate resources 310 that are probabilistically relevant to the input query. Resource retrieval module 216 indexes the located resources and returns the indexed resources to answer generator 222 as message 410. The answer generator 222 may retrieve the actual resources 310 from data store 250 using the indexed resources and execute augmenting module 218 to construct an augmented input query by adding the retrieved resources 310 to the input query as context.

The answer generator 222 may submit the augmented input query to the generative AI model 240 as message 412. The generative AI model 240 applies its learned knowledge to generate answer(s) that are relevant to the input query according to the context defined by the added resources. The generative AI model 240 returns a response message 414, which includes textual answer(s) to the question(s) from message 402.

The answer generator 222 may forward the response to the UI 220 as message 416, shown as answer(s) 304 in FIG. 3. The UI 220 can present the answer(s) 304 to the user, for example, by displaying the textual answer(s) 304 in a textbox, chatbox, or the like within or overlaid on a page of the UI 220, as described above.

As shown in FIG. 3, the answer(s) obtained by the answer generator 222 can be provided to the UI flow generator 224 as answer(s) 306 for generating an interactive UI walkthrough relevant to the question(s) 302. The message flow 500 execute by the UI flow generator 224 may be similar to message flow 400 described above, except as provided herein.

For example, the answer generator 222 may provide the answer(s) 306 to the UI flow generator 224 as message 502 of FIG. 5. The UI flow generator 224 can forward the answer(s) 306 to the query processing module 215 as message 504. As described above, the query processing module 215 generates an answer query as a numerical representation of the answer(s) (e.g., vectorized embeddings of the answer(s)). The query processing module 215 returns the answer query to the UI flow generator 224 as message 506.

The UI flow generator 224 can send message 508 requesting a UI mapping document 312 stored to data store 250, in examples. The UI mapping document 312 can be provided to the UI flow generator 224 as message 510. The UI flow generator 224 may construct an augmented answer query by adding the UI mapping document 312 to the answer query as context.

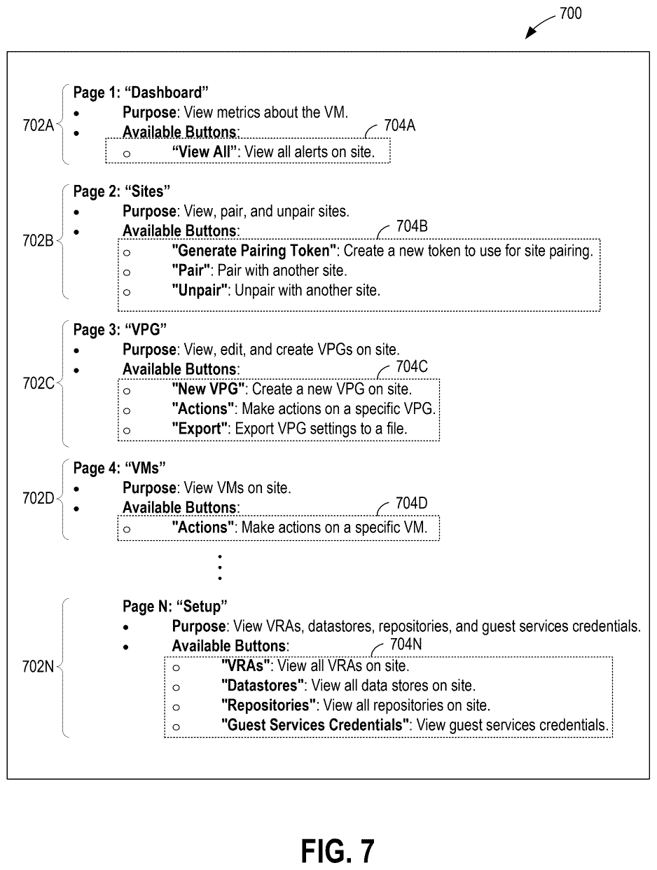

The UI mapping document 312 may represent the UI 220 as a set of pages and components by mapping the components to each page, as described above in connection with FIG. 1. Aspects of the UI 220 divided across the set of pages can be tagged, e.g., names can be assigned to each component (e.g., button, control, setting, and so on). The UI mapping document 312 can be created that describes each component and the component's purpose mapped to each page. In some examples, a UI mapping may be provided as a set of documents, each of which represent one or more pages of the UI 220. An illustrative example of a UI mapping document 312 will be described below in connection with FIG. 7.

The UI flow generator 224 may submit the augmented answer query to the generative AI model 240 as message 512. The generative AI model 240 applies its learned knowledge to generate a UI flow as an ordered set of steps that can be executed within the UI to effectuate the answer(s) 306. The generative AI model 240 returns the UI flow as message 514, which includes a textual UI flow that sets forth the ordered set of steps for executing tasks set forth by the answer(s) of message 502.

In examples, the UI flow may comprise an ordered set of one or more pages of UI 220, starting at a first page, that incrementally steps through the one or more pages to be navigated through to effectuate the answer. The UI flow may also include an order set of one or more components of the UI that can be sequentially executed to perform functions and operations of the UI 220. As noted above, sets of components are associated with a respective page (e.g., those components that can be executed from the respective page or are otherwise displayed on the respective page). As such, the UI flow may group the one or more components according to the order of the one or more pages. That is for example, the UI flow may specify a first page and one or more components to be executed to access a second page, which can be followed by a second page and one or more components to be executed from the second page, and so on until tasks set forth by the answer(s) are executed. In examples, the UI flow may be provided as a textual flow containing the ordered set of components and/or pages.

The UI flow generator 224 may construct an interactive UI walkthrough from the UI flow. For example, UI flow generator 224 may build the interactive UI walkthrough as a data object containing the UI flow. In examples, the data object may be an executable data object that can be processed and executed by the UI 220. For example, the UI flow generator 224 may build a JSON block that contains the UI flow (e.g., a block of JSON objects, where each object corresponds to a step and action for executing that step) and executable syntax for automating the interactive UI walkthrough. For example, each step may be associated with one or more graphical attributes that can be adjusted (e.g., pulsed, changed, brightened, greyed out, etc.) to graphically highlight components and/or pages for executing the step.

The UI flow generator 224 may forward the interactive UI walkthrough to the UI 220 as message 516, shown as UI walkthrough 308 in FIG. 3. The UI 220 can present the UI walkthrough by executing the data object to guide the user through the UI flow as an interactive walkthrough that directs the user through the order steps (e.g., ordered JSON objects), while the user interacts with the UI 122 to complete the steps in real-time. For example, the user may interact with the UI 122 at certain steps to effectuate the steps and transition the UI walkthrough to a next step of the UI flow, thereby providing the interactive UI walkthrough that accomplishes the prompted tasks. In examples, responsive to interactions by the user performing a step, a next step in the ordered steps can be emphasized by automatically rendering the graphical representation/visualizations on the components and/or pages associated with the step within the UI 220, thereby drawing the user's attention to actions needed to completed the next step of the task. Each step may be automatically rendered in real-time responsive to user interactions completing a preceding step.

Accordingly, system 200 can be capable of dynamically generated interactive UI walkthroughs according to question(s) submitted by users seeking to perform tasks on a UI 220. That is, for example, distinct walkthroughs can be generated on-demand that are specifically targeted to address different question(s) and interactively guide a user through the tasks to effectuate the answer(s) in real-time. Different questions can provide different walkthroughs unique to each question. Thus, examples herein can be adaptable to any conceivable questions or issues, whereas conventional walkthroughs relied on static representations that may not capture all conceivable ways a user may interact with a UI. Additionally, the interactive step by step guide through the walkthrough may alleviate user difficulty navigating the UI.

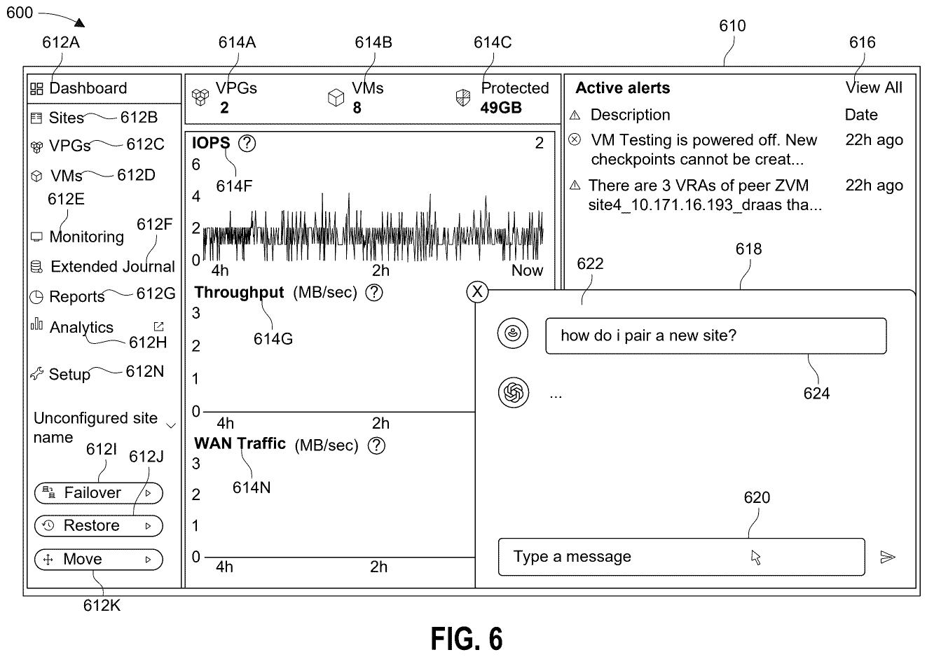

FIG. 6 depicts an example UI 600 that may be utilized for generating interactive UI walkthroughs, in accordance with an example of the present disclosure. UI 600 may be an example implementation of UI 122 and/or 220 described above. FIG. 6 displays a visual representation (e.g., a GUI) a page 610 of the UI 600 rendered and displayed on a screen of a computing device (e.g., a frontend system 120). In the example of FIG. 6, page 610 illustrates a dashboard page 610 of UI 600 for a disaster recovery and data protection service hosted by a backend server (e.g., backend server 130 of FIG. 1). Page 610 includes numerous components, only some of which are labeled with reference numbers for illustrative purposes. For example, page 610 includes buttons 612A-612N for navigating between various pages, such as “Dashboard” page, “Sites” page, “VPGs” page, “VMs” page, “Monitoring” page, “Extended Journal” page, “Reports” page, “Analytics” page, and “Setup” page, to name a few. Page 610 also include components 614A-614N as example graphs of certain performance metrics that are monitored, other status data, and counters of VPGs, VMs, protected memory, compression percentage, and average RPO; button 616 (e.g., a “View all” button to view all active alerts); and an chatbox 618. Chatbox 618 also include a text input area 620 and a chat window 622.

FIG. 7 depicts an example UI mapping document of UI 600, in accordance with an example of the present disclosure. The UI mapping document 700 can be stored in a data store, such as data store 150 and/or 250 described above. The UI mapping represents the UI 600 as a set of page entries 702A-702N corresponding to each page of UI 600 (e.g., pages 612A-612N). In the example of FIG. 7, five entries for five pages of UI 600. However, any number of pages may be represented in the UI mapping based on the UI being represented and the number of pages desired for a given document. In this example, page entries 702A-702N correspond to the “Dashboard” page 612A; “Sites” page 612B; “VPGs” page 612C; “VMs” page 612D; and “Setup” page 612N. Each page entries 702A-702N can be assigned a name (e.g., tagged), for example, page 702A is tagged with name “Dashboard.” A purpose can be defined for each page, such as “view metrics about the VM” in the case of page entry 702A and available buttons 704A-704N can be defined, such as “View All” button for entry 702A. The buttons 704A-704N represent the actual buttons contained in a respective page (e.g., buttons 704A correspond to button 616 of FIG. 6). Thus, UI mapping document 700 describes each page and component and associates each component with a respective page.

Returning to FIG. 6, a question 624 (“how do I pair a new site?”) is shown displayed in the chat window 622. The question 624 may be input into text input area 620 via user interactions, which causes the question 624 to be submitted to the UI 600 and displayed in the chat window 622, in this example. Additionally, the UI 600 can submit the question 624 for generating an interactive UI walkthrough to guide the user through the steps for pairing a new site.

For example, the disaster recovery and data protection service hosted by the backend server (e.g., backend server 130 of FIG. 1) may comprise a UI walkthrough agent (e.g., UI walkthrough agent 110 of FIG. 1 and/or system 200 of FIG. 2). In this case, the UI 600 may submit the question 624 to the UI walkthrough agent to generate an interactive walkthrough that is specific to performing the task prompted by question 624 (e.g., pairing a new site)

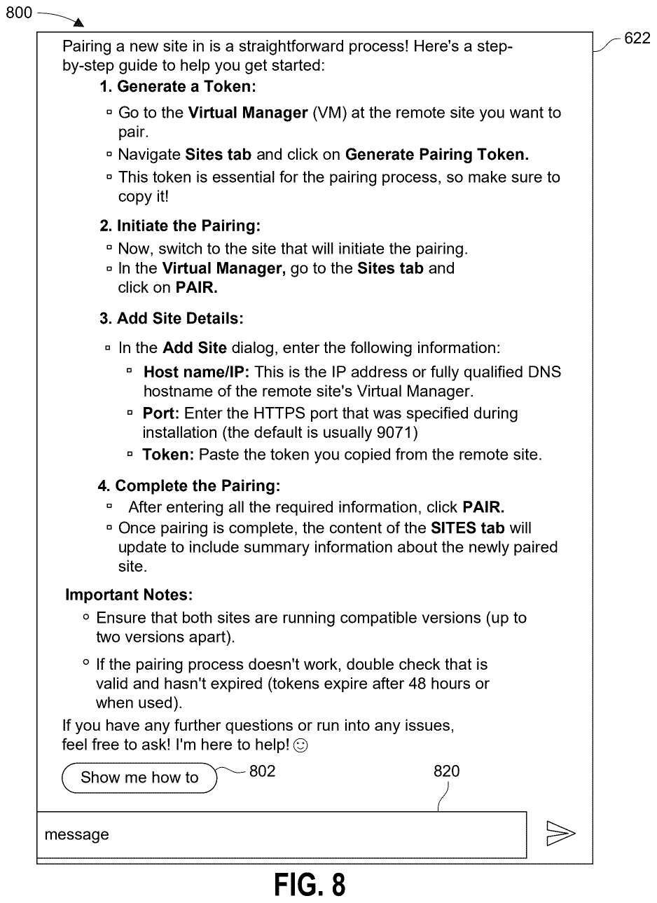

Referring to FIGS. 2-4, the UI 600 may submit the question 624 to an answer generator 222 to generate one or more answers to the question. For example, FIG. 8 illustrates an example answer 800 that can be generated by the answer generator. The answer 800 is illustratively shown as being generated and displayed in the chat window 624 following to and responsive to the question 624. The answer 800 may be generated using the retrieval engine 214 and generative AI model 240 as described above. The answer 800 may include an interactive button 802 that may be interacted with by the user (e.g., a click, gesture, auditory command or the like) to trigger generating an interactive UI walkthrough, in some examples. In other examples, the interactive UI walkthrough may be triggered automatically based on (e.g., in response to) generating the answer 800.

In either case, the answer generator 222 may submit the answer 800 to the UI flow generator 224 to generate the interactive UI walkthrough. For example, the UI flow generator 224 executes the query processing module 215 to convert the answer 800 into a numerical representation and retrieves the UI mapping document 700. The UI flow generator 224 constructs a context for the answer by combining the UI mapping with the answer to create an augmented query that can be submitted to the generative AI model 240. IN an example, the augmented query may be construct as “Your job is to return the correct value from the UI mapping document: [page, button]. Return the page and button that are relevant to the answer query. If none of the mapping are relevant, or the answer is not about how to do the action, then return false.”

The generative AI model 240 reads the augmented query and analyzes the UI mapping document to generate a structured textual response. For example, the generative AI model 240 may analyze the UI mapping document 700 to identify one or more pages and components of UI 600 that provide the steps for executing the action. Returning to the above example, response can be formatted as a JSON block of JSON objects representing ordered steps for executing the prompted action. For example, in the above examples, a JSON block can be provided as “{“answer”: “To pair sites, go to the Sites page and select Pair.”, “ui_actions”: [“Sites”, “Pair”]}. The UI flow generator 224 adds JSON syntax associating graphical attributes to each ui_action that can be adjusted to highlight the ui_actions.

The UI flow, as a JSON block in some examples, can be provided to the frontend system running UI 600, which can include a parser and a renderer. The parser at the frontend system extracts the “ui_actions” list and associated graphical attributes and adjustments. For each action in the list, the renderer executes the graphical attributes by making the prescribed changes to the visual properties of the components listed, thereby highlighting or focusing the user's attention to the corresponding component. The UI 600 executes each action in the list in the ordered listed responsive to user interactions executing each action.

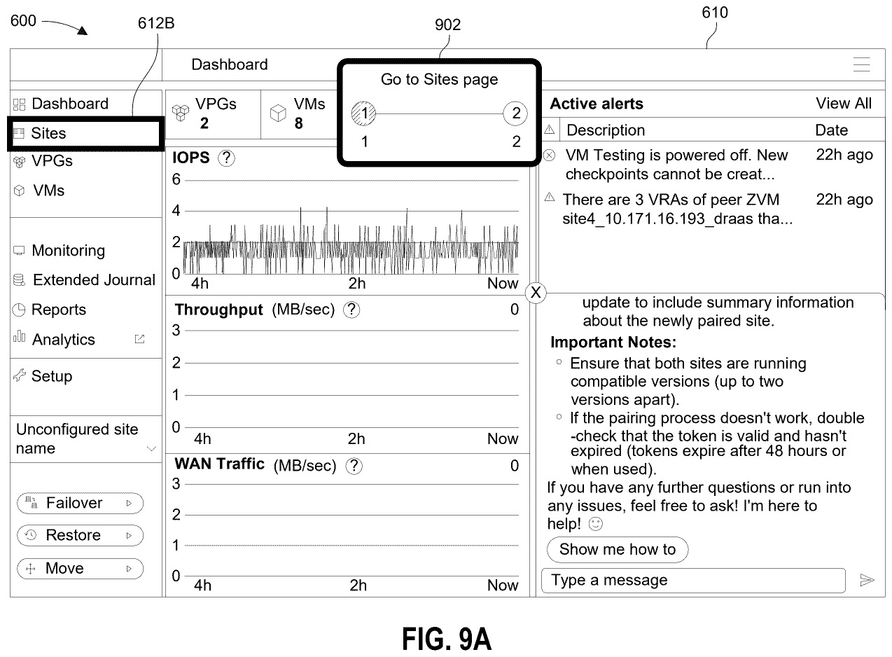

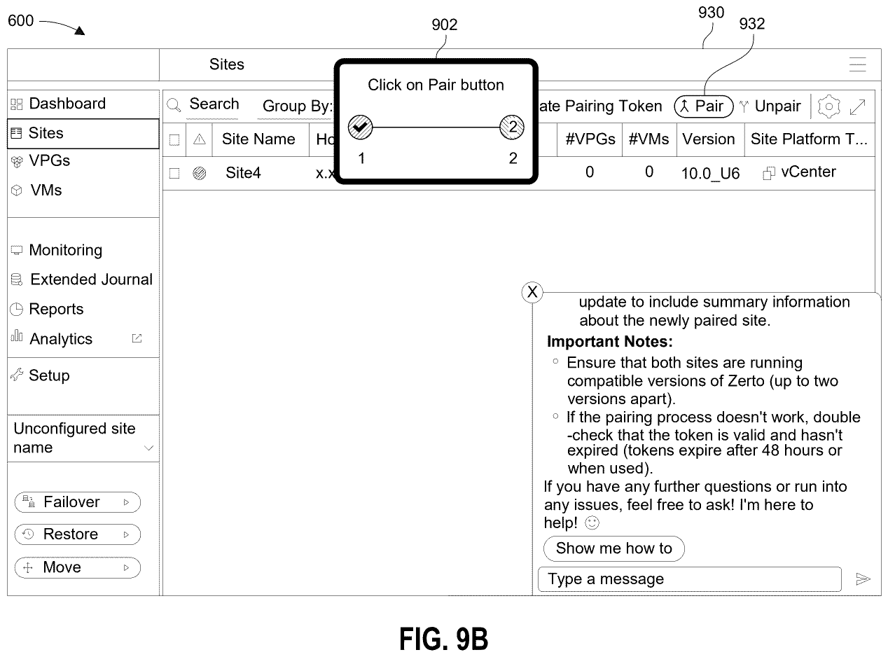

FIGS. 9A and 9B depict examples steps of an interactive walkthrough, according to an example implementation. More particularly, FIGS. 9A and 9B depicts an interactive UI walkthrough for accomplishing the task prompted by question 624 of FIG. 6 (e.g., pair a new site) by constructing a UI flow from answer 800 and UI mapping document 700. FIG. 9A depicts a first step at a first page 610 of UI 600 (e.g., dashboard page) by adjusting the color of the first page 610 (e.g., greyed out) and highlighting the button 612B for navigating to the Sites page. Additionally, a step counter window 902 can be generated and overlaid on page 610 that depicts a number of steps and describes the action for a current step (e.g., “Go to Sites page”). Upon the user interacting with button 612B, UI 600 transitions to a second page 930 (e.g., the “Sites” page in this example) as shown in FIG. 9B. The UI flow proceeds to the next action in the list, which in this case is to execute button 932 (e.g., “Pair” button) to pair a new site. The step counter window 902 is updated to the current step (e.g., “Click on Pair button”) as the second step. Upon interacting with the button 612B, a popup window may be generated that can be overlaid on page 930 for entering information for the new site to be paired.

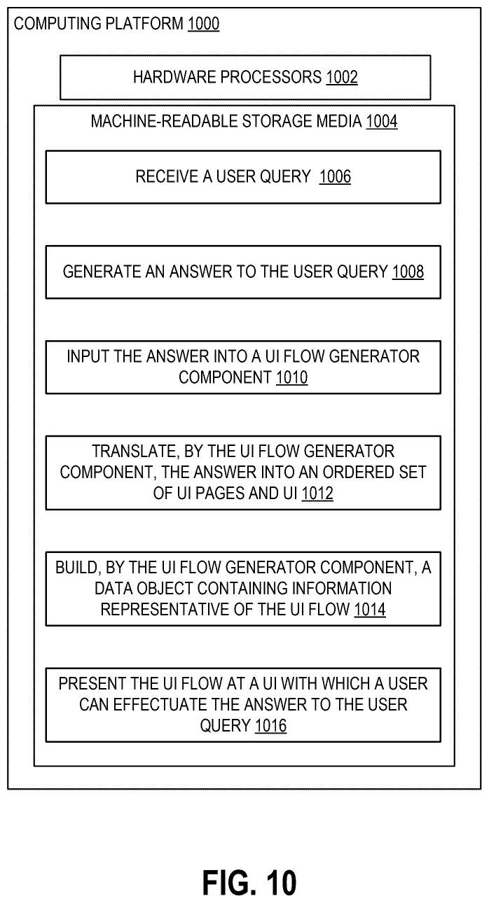

FIG. 10 illustrates a computing component that may be used to implement dynamic generation of interactive UI walkthroughs in accordance with various examples of the disclosed technology. Referring now to FIG. 10, computing component 1000 may be, for example, a server computer, a controller, or any other similar computing component capable of processing data. In the example implementation of FIG. 10, the computing component 1000 includes a hardware processor 1002, and machine-readable storage medium for 1004.

Hardware processor 1002 may be one or more central processing units (CPUs), semiconductor-based microprocessors, and/or other hardware devices suitable for retrieval and execution of instructions stored in machine-readable storage medium 1004. Hardware processor 1002 may fetch, decode, and execute instructions, such as instructions 1006-1016, to control processes or operations disclosed herein. As an alternative or in addition to retrieving and executing instructions, hardware processor 1002 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 1004, may be any electronic, magnetic, optical, or other physical storage device that contains or stores executable instructions. Thus, machine-readable storage medium 1004 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 1004 may be a non-transitory storage medium, where the term “non-transitory” does not encompass transitory propagating signals. As described in detail below, machine-readable storage medium 1004 may be encoded with executable instructions, for example, instructions 1006-1016.

Hardware processor 1002 may execute instruction 1006 to receive a user query. In examples, the user query is based on or otherwise comprises a question regarding a UI, such as the use, operations, or functionality of the UI, for example, as described in connection with FIGS. 1-3. In examples, the user query can be received by an answer generator, such as answer generator 222 of FIG. 2. In some examples, the user query can be received from a UI component of the UI, for example, through a chatbox or other text area configured to receive user inputs, as described above.

Hardware processor 1002 may execute instruction 1008 to generate an answer to the user query. In examples, the answer can be generated by the answer generator (e.g., answer generator 222), for example, by leveraging a generative AI model (e.g., generative AI model 140 and/or 240). In some examples, the user query can be augmented using RAG techniques, for example, by locating and adding resources descriptive of the UI that are probabilistically relevant to the user query, as described above in connection with FIGS. 1-3. For example, the user query can be converted to a numerical representation used to locate similar numerical representations of resources. The located numerical representations can be translated back to the actual resources and added to the user query to construct an augmented user query that is provided to the generative AI model.

Hardware processor 1002 may execute instruction 1010 to input the answer into a UI flow generator component. The UI flow generator component may be the UI flow generator 224 of FIG. 2 in an example.

Hardware processor 1002 may execute instruction 1012 to translate, by the UI flow generator component, the answer into an ordered set of UI pages and UI components. For example, the ordered set of UI pages and UI components can be generated by the UI flow generator leveraging the generative AI model (e.g., generative AI model 140 and/or 240). In some examples, the answer (i.e., an answer query) can be augmented using RAG techniques, for example, by adding a UI mapping document representative of a structural layout of the UI by mapping UI components to respective UI pages. The augmented answer can be provided to the generative AI model to generate the ordered set of UI pages and UI components, as described above in connection with FIGS. 1-3.

Hardware processor 1002 may execute instruction 1014 to build, by the UI flow generator component, a data object containing information representative of the UI flow. For example, the ordered set may be used by the UI flow generator to build a data object of the UI flow that can be executed at the UI, step by step, as the interactive UI walkthrough to guide the user through the steps, as described above in connection with FIGS. 1-3. In examples, the data object can be provided as a JavaScript Object Notation (JSON) block that includes a plurality of JSON objects of the ordered set of UI pages and UI components.

Hardware processor 1002 may execute instruction 1016 to present the UI flow at a UI by rendering the UI as a GUI on a display through which a user can effectuate the answer to the user query. For example, the UI flow generator component may transmit the data object to a frontend system running the UI (e.g., an end-user device). The UI may execute the data object to guide the user through the ordered set of UI pages and UI components. For examples, the data object may be executed to cause a first UI component of the ordered set within a first UI page of the ordered set to be highlighted in a GUI rendered on a display, for example, by modulating or otherwise adjusting a graphical attribute of the first UI component. Upon the user interacting with the first UI component within the UI, the user may be navigated to a second UI page of the ordered set and a second UI component may be highlighted.

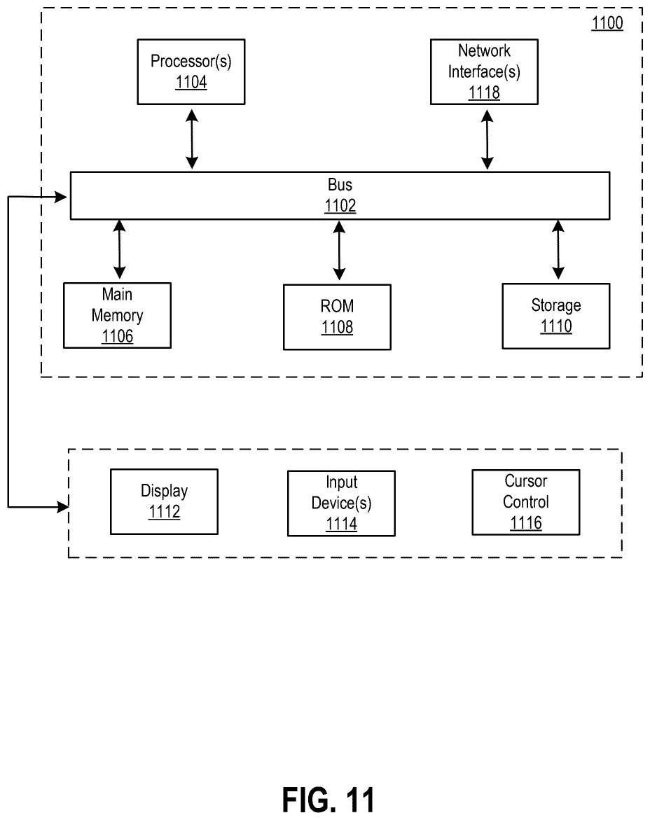

FIG. 11 depicts a block diagram of an example computer system 1100 in which various examples of the disclosed technology described herein may be implemented. The computer system 1100 includes a bus 1102 or other communication mechanism for communicating information, one or more hardware processors 1104 coupled with bus 1102 for processing information. Hardware processor(s) 1104 may be, for example, one or more general purpose microprocessors. The computer system 1100 may be implemented as one or more component of the systems 100 and/or 200 described in connection with FIGS. 1 and 2. For example, computer system 1100 may be implemented as frontend system 120, backend server 130, system 200, etc.

The computer system 1100 also includes a main memory 1106, such as a random access memory (RAM), cache and/or other dynamic storage devices, coupled to bus 1102 for storing information and instructions to be executed by processor 1104. Main memory 1106 also may be used for storing temporary variables or other intermediate information during execution of instructions to be executed by processor 1104. Such instructions, when stored in storage media accessible to processor 1104, render computer system 1100 into a special-purpose machine that is customized to perform the operations specified in the instructions. For example, main memory 1106 may store instructions, that when executed by processor(s) 1104, cause computer system 1100 to perform one or more of the operations described in connection with FIGS. 4, 5, and 10.

The computer system 1100 further includes a read only memory (ROM) 1108 or other static storage device coupled to bus 1102 for storing static information and instructions for processor 1104. A storage device 1110, such as a magnetic disk, optical disk, or USB thumb drive (Flash drive), etc., is provided and coupled to bus 1102 for storing information and instructions.

The computer system 1100 may be coupled via bus 1102 to a display 1112, such as a liquid crystal display (LCD) (or touch screen), for displaying information to a computer user. An input device 1114, including alphanumeric and other keys, is coupled to bus 1102 for communicating information and command selections to processor 1104. Another type of user input device is cursor control 1116, such as a mouse, a trackball, or cursor direction keys for communicating direction information and command selections to processor 1104 and for controlling cursor movement on display 1112. In some examples, the same direction information and command selections as cursor control may be implemented via receiving touches on a touch screen without a cursor.

The computing system 1100 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1100 may implement the techniques described herein using customized hard-wired logic, one or more ASICs or FPGAs, firmware and/or program logic which in combination with the computer system causes or programs computer system 1100 to be a special-purpose machine. According to one example of the disclosed technology, the techniques herein are performed by computer system 1100 in response to processor(s) 1104 executing one or more sequences of one or more instructions contained in main memory 1106. Such instructions may be read into main memory 1106 from another storage medium, such as storage device 1110. Execution of the sequences of instructions contained in main memory 1106 causes processor(s) 1104 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1110. Volatile media includes dynamic memory, such as main memory 1106. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1102. Transmission media can also take the form of acoustic or light waves, such as those generated during radio-wave and infra-red data communications.

The computer system 1100 also includes a network interface 1118 (also referred to as a communication interface) coupled to bus 1102. Network interface 1118 provides a two-way data communication coupling to one or more network links that are connected to one or more local networks. For example, communication interface 1118 may be an integrated services digital network (ISDN) card, cable modem, satellite modem, or a modem to provide a data communication connection to a corresponding type of telephone line. As another example, network interface 1118 may be a local area network (LAN) card to provide a data communication connection to a compatible LAN (or WAN component to communicated with a WAN). Wireless links may also be implemented. In any such implementation, network interface 1118 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through network interface 1118, which carry the digital data to and from computer system 1100, are example forms of transmission media.

The computer system 1100 can send messages and receive data, including program code, through the network(s), network link and network interface 1118. In the Internet example, a server might transmit a requested code for an application program through the Internet, the ISP, the local network and the network interface 1118.

The received code may be executed by processor 1104 as it is received, and/or stored in storage device 1110, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 1100.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method comprising:
receiving, at an answer generator component, a user query;
generating, by the answer generator component, an answer to the user query;
inputting the answer into a user interface (UI) flow generator component;
translating, by the UI flow generator component, the answer into an ordered set of UI pages and UI components making up a UI flow;
building, by the UI flow generator component, a data object containing information representative of the UI flow; and
presenting the UI flow at a UI by rendering the UI as a graphical user interface (GUI) on a display through which a user can effectuate the answer to the user query.

2. The method of claim 1, wherein the user query comprises a question regarding the UI.

3. The method of claim 1, wherein the user query is received by the answer generator from a UI component of the UI.

4. The method of claim 1, wherein the data object is provided as a JavaScript Object Notation (JSON) block, the JSON block comprising a plurality of JSON objects of the ordered set of UI pages and UI components.

5. The method of claim 1, wherein the UI components comprises one or more of: references, textboxes, text areas, checkboxes, chatboxes, drop-down menus, interactive buttons, and executable scripts.

6. The method of claim 1, wherein presenting the UI flow at the UI comprises:
highlighting a first UI component of the ordered set within a first UI page of the ordered set; and
responsive to a user interaction with the first UI component in the UI, automatically navigating to a second UI page of the ordered set and highlighting a second UI component within the second UI page.

7. The method of claim 1, wherein generating the answer to the user query comprises applying the user query to a large language model.

8. The method of claim 7, wherein generating the answer to the user query comprises performing retrieval-augmented generation that augments the user query by adding one or more resources descriptive of the UI that are probabilistically relevant to the user query.

9. The method of claim 1, wherein translating the answer into an ordered set of UI pages and UI components comprises applying the answer to a large language model as an answer query.

10. The method of claim 9, wherein the answer query is augmented by adding a UI mapping document representative of a structural layout of the UI by mapping UI components to respective UI pages.

11. A system, comprising:
a memory storing instructions; and
a processor connected to the memory and configured to execute the instructions to:
receive a user query including a question regarding a user interface (UI);
generate an answer to the user query;
translate the answer into an ordered set of UI pages and UI components making up a UI flow;
build a data object containing information representative of the UI flow; and
present the UI flow at a UI by rendering the UI as a graphical user interface (GUI) on a display through which a user can effectuate the answer to the user query.

12. The system of claim 11, wherein the user query comprises a question regarding the UI.

13. The system of claim 11, wherein the data object is provided as a JavaScript Object Notation (JSON) block, the JSON block comprising a plurality of JSON objects of the ordered set of UI pages and UI components.

14. The system of claim 11, wherein presenting the UI flow at the UI comprises:
adjusting a graphical attribute of a first UI component of the ordered set within a first UI page of the ordered set; and
responsive to a user interaction with the first UI component in the UI, automatically navigating to a second UI page of the ordered set and adjusting a graphical attribute of a second UI component within the second UI page.

15. The system of claim 11, wherein generating the answer to the user query comprises:
augmenting the user query by adding one or more resources descriptive of the UI that are probabilistically relevant to the user query; and
applying the augmented user query to a large language model (LLM).

16. The system of claim 15, wherein translating the answer into an ordered set of UI pages and UI components comprises:
augmenting the answer by adding a UI mapping document representative of a structural layout of the UI by mapping UI components to respective UI pages; and
applying the augmented answer to the LLM.

17. A non-transitory computer-readable storage medium storing instructions that, when executed by a processor, cause the processor to:
receive a user query from a user interface (UI), wherein the user query comprises a question about the UI, wherein the UI comprises a plurality of pages and a plurality of buttons;
generate an answer to the user query by applying the user query to a large language model (LLM);
generate a UI flow as an ordered set of buttons and pages from the answer and a mapping of the plurality of UI components to the plurality of pages applied to the LLM;
construct a UI walkthrough from the ordered set of buttons and pages; and
guiding a user to execute the answer by iteratively displaying the ordered set of UI components and UI pages on the UI.

18. The non-transitory computer-readable medium of claim 17, wherein the UI walkthrough is provided as a JavaScript Object Notation (JSON) block, the JSON block comprising a plurality of JSON objects of the ordered set of components and pages.

19. The non-transitory computer-readable medium of claim 17, wherein generating the answer comprises:
converting the user query into a vectorized embedding;
locating, in a vector database, one or more vectorized embeddings of resources descriptive of the UI;
augmenting the user query with the located resources; and
applying the augmented user query to the LLM.

20. The non-transitory computer-readable medium of claim 17, wherein guiding a user to execute the answer by iteratively displaying the ordered set of UI components and UI pages on the UI is based on user interaction at each set of UI components and UI pages of the ordered set to trigger displaying a next set of UI components and UI pages of the ordered set.
